(19) United States
(12) Patent Application Publication
(10) Pub. No.: US 2013/0100650 A1
(43) Pub. Date: Apr. 25, 2013

(54) DOWNLIGHT LED RETROFIT KIT

(71) Applicant: Andrew Howard Beregszaszi, Philadelphia, PA (US)

(72) Inventor: Andrew Howard Beregszaszi, Philadelphia, PA (US)

(73) Assignee: LUMENOPTIX, LLC, Philadelphia, PA (US)

(21) Appl. No.: 13/279,554

(22) Filed: Oct. 24, 2011

(51) Int. Cl. F21S 8/00; B23P 23/00

(52) U.S. Cl. 362/145; 29/401.1

(57) ABSTRACT

A light emitting diode (LED) retrofit downlight light module (DLM) having a housing with an LED downlighting module containing a lighting exit port and connected to a reflector and trim ring having an illumination outlet. The DLM is inserted into an access hole after the existing fixture has been removed. By inserting the DLM into the access hole, a retention device compresses on contact with the entry surface surrounding the hole perimeter. Subsequent to the pivot point of the retention device passing the first surface, the retention device begins to apply a frictional force to the hole perimeter, thereby retaining the DLM within the access hole, without need of tools during installation.

### FIELD OF THE INVENTION

The present invention pertains to lighting retrofit kits, but more particularly, to an energy efficient LED downlight retrofit kit and utilizes a replacement technique not requiring tools.

### BACKGROUND OF THE INVENTION

The present invention relates to lighting, also called illumination, which is the deliberate application of light to achieve an aesthetic or practical effect. Lighting includes the use of artificial light sources such as lamps and natural illumination from daylight. Daylighting, in which sunlight enters a room through windows, skylights, and other ways, is often used as the main source of light during the daytime in buildings, given its high quality and low cost. Proper lighting can enhance task performance and aesthetics, while energy waste and adverse health effects of poorly designed lighting also occur. Indoor lighting is a form of fixture or furnishing, and a key part of interior design.

Artificial lighting, however, represents a major component of energy consumption, accounting for a significant part of all energy consumed worldwide. Artificial lighting is most commonly provided today by electric lights, but gas lighting, candles, or oil lamps were used in the past, and still are used in certain situations.

Generally, lighting types are classified by their intended use: task lighting, localized, or general, depending largely on the distribution of the light produced by the fixture. Task lighting is mainly functional and is usually the most concentrated, for purposes such as performing detailed work, reading or inspecting materials. Localized or accent lighting is mainly decorative, intended to highlight pictures, plants, or other elements of interior design. General lighting, sometimes referred to as ambient light, fills the gap between the two and is intended for overall illumination of an area.

Several lighting methods exist, with downlighting being the most common. Downlighting consists of fixtures located on or recessed into an elevated place, casting light downward. This is the most used method for both offices and homes. Although downlighting is relatively easy to design, problems exist with glare and excess energy consumption due to a large number of fittings required for lighting coverage of an area. Uplighting, or indirect lighting, is less common and often is used to bounce light off the ceiling and back down. It is used in lighting applications that require minimal glare and uniform general illuminance levels. Uplighting uses a diffuse surface to reflect light in a space and can minimize disabling glare on computer displays and other dark glossy surfaces. A more uniform presentation of the light output results during operation. Front lighting is also quite common, but tends to make a subject look flat, as it casts almost no visible shadows. Lighting from the side is less common, as it is likely to produce eye level glare. Backlighting, either around or through an object, is used mainly for accent.

A recessed light or downlight, sometimes called a can light, is a light fixture installed into a hollow opening in a ceiling. When installed it appears to be light shining from a hole in the ceiling, concentrating the light in a downward direction as a broad floodlight or narrow spotlight. There are two main components to recessed lights: the trim and the housing. The trim is the visible portion of the light fixture. It is the insert seen when looking up into the fixture, and also includes the thin lining around the edge of the light. The housing is the fixture itself that is installed inside the ceiling and contains the lamp holder.

In North America, Underwriters Laboratories (UL) UL1598 is the standard for safety of luminaries, with the recessed housings generally falling into one of four categories: IC or insulation contact rated new construction housings attached to the ceiling supports before the ceiling surface is installed; non-IC rated new construction housings used in the same situations as the IC rated new construction housings, but require no contact with insulation and at least 3 in (7.6 cm) spacing from insulation; IC rated remodel housings used in existing ceilings where insulation is present and in contact with the fixture; and non-IC rated remodel housings used for existing ceilings where, ideally, no insulation is present; however, these non-IC rated remodel housing also require no contact with insulation and at least 3 in (7.6 cm) spacing from insulation.

The main feature of the housing is to ensure that no flammable materials come into contact with the hot lighting fixture. Defective housing of downlights can be a fire hazard, although all new downlights contain a self-resetting thermal switch for safety. The housing can also be air tight, meaning no air can escape into the space above, thus reducing both heating and cooling costs.

UL also has standards for retrofit kits with the following nomenclature: luminaire conversions, retrofit (UL/IEUQ); and lamps, self-ballasted, light-emitting-diode type (UL/OOLV).

Artificial lighting is constantly evolving, and has advanced significantly in recent years. For example, incandescent, metal halide (MH), and high-pressure sodium lamps (HPS) that have been so prevalent in recent history are now being replaced with compact fluorescent (CFL), induction, light emitting diode (LED), and other newer technologies. Such newer technology provides several advantages, such as lower energy consumption, longer operational life, improved light output and distribution; less local heat gain, municipal rebates, and government refunds. The use of such technology can also be the result of government compulsion through environmental laws. As the technology has evolved, existing lights and associated fixtures of an older technology generally must be replaced to take advantage of the new features of the new lights.

Although new buildings can install new technology while under construction, older buildings do not have that capability. A similar movement to new technology in the TV industry, where the tried and true cathode ray tube, with its concomitant bulk size, weight, and energy consumption is being replaced with plasma, cold cathode tube liquid crystal display (LCD), LED LCD, organic light emitting diode (OLED), etc, where the new technologies are lighter, brighter, easier to use, and feature a host of other benefits.

LED lamps offer several advantages over other lighting types, including improved quality, performance, lifespan and cost, and their use and acceptance has been growing. LED lighting provides generally reduced power consumption per unit lumen. LEDs convert more input energy into actual photons, not into waste heat common with other types of lights. A recent study concluded LED lamps use only 10% of the energy, compact fluorescent lamps use 20% of the energy, and energy saving halogen lamps use 70% of the input energy of an incandescent bulb for an equivalent output.

Existing buildings that require a retrofit to replace existing lights with a new type of lighting may, however, require a time consuming and expensive removal and replacement (R&R) process of the entire existing lighting fixture and, possibly, the wiring to the housing.

A drawback of LED lighting systems can be the cost and time required in removing conventional, non-LED-based light fixtures and installing new light fixtures that are designed and optimized for LED-based lamps. Positioning and controlling the light emitted from an LED fixture may require a different technique than such actions of light from a conventional lamp. Furthermore, power converters are required to convert line AC to 12-24V, constant current to drive the LEDs. Some fixtures typically include circuitry to rectify the AC power and to convert the voltage to a level usable by the internal LED elements.

Attempts have been made to fit LED technology into a standard lamp fixture, incorporating the driver circuitry, power conversion, and heat sinking. The outcome is generally less than satisfactory, wherein the LED device gets too hot and the LED loses efficiency, or power conversion is not optimized so the lamp does not operate at peak effectiveness.

Additionally, the retrofitting of fixtures may sometimes require additional labor costs due to the use of saws, drills, and other precision tools to fit a new fixture into a void left by the removal of an old fixture. More than one person may be required to perform modifications due to local regulation of certain trades, whereby an electrician, drywall person, toolmaker, carpenter, general foreman and others may be necessitated by law.

### DISCUSSION OF THE RELATED ART

U.S. Pat. No. 7,959,332 for LIGHT EMITTING DIODE RECESSED LIGHT FIXTURE, issued to Tickner et al., on Jun. 14, 2011, discloses a recessed light fixture with an LED module that includes a single LED package configured to generate all light emitted by the recessed light fixture. The LED package can include multiple LEDs mounted to a common substrate. The LED package can be coupled to a heat sink for dissipating heat from the LEDs. The heat sink can include a core member from which fins extend. Each fin can include one or more straight and/or curved portions. A reflector housing may be coupled to the heat sink and configured to receive a reflector. The reflector can have any geometry, such as a bell-shape including two radii of curvature that join together at an inflection point. An optic coupler can be coupled to the reflector housing and configured to cover electrical connections at the substrate and to guide light emitted by the LED package.

U.S. Pat. No. 7,845,832 for LAMP DEVICE AND METHOD TO RETROFIT A LIGHTING FIXTURE, issued to Boyer on Dec. 7, 2010, and U.S. Pat. No. 7,677,766 for LED LAMP DEVICE AND METHOD TO RETROFIT A LIGHTING FIXTURE, issued to Boyer on Mar. 16, 2010, disclose a device and method for retrofitting a lamp socket that employs an incandescent or metal halide lamp light fixture, to use with another lamp assembly. The lamp fixture has a collar with a base and an annular outer wall extending out from the base. The LED lamp device includes a neck base having an annular outer wall having a shaped outside surface that is placed into direct surface contact with the inner surface of the annular outer wall of the collar, to establish an effective heat-transferring interface.

U.S. Pat. No. 6,739,734 for LED RETROFIT METHOD AND KIT FOR CONVERTING FLUORESCENT LUMINARIES, issued to Hulgan on May 25, 2004, discloses a method of converting fluorescent luminaires, or luminaries, into LED luminaires. The most preferred method retrofits a commercial fluorescent light fixture, especially one that uses T12 lamps or T8 lamps, without requiring removal of the fixture housing. The fluorescent luminaire is stripped of its lamps, wireway cover, ballast(s) and tombstones. A LED retro-reflector is mounted within the fixture housing to conceal an LED power supply and to provide a surface for mounting LED light strips. Any existing diffuser or louver that was part of the fluorescent luminaire may be replaced after the LED retrofit has been completed.

U.S. Pat. No. 5,997,158 for RETROFIT CANOPY LUMINAIRE AND METHOD OF INSTALLING SAME, issued to Fischer et al., on Dec. 7, 1999, discloses a retrofit luminaire assembly for mounting in an existing canopy fixture housing and methods of installing same. The retrofit luminaire assembly includes a planar panel having electrical control elements mounted to an upper surface of the panel. A lamp is received in a lamp socket mounted to the panel with a light-emitting section of the lamp extending away from a lower surface of the panel. A lens is mounted to the lower surface of the panel for enclosing the light-emitting section of the lamp. The panel preferably has a pair of oppositely directed pivot members which are adapted to engage with inwardly directed flanges of the canopy fixture housing to removably and pivotally support the panel for movement between a vertical, inoperative position and a horizontal, operative position.

United States Published Patent Application No. 2005/0207152 for LIGHTING ELEMENT USING ELECTRONICALLY ACTIVATED LIGHT EMITTING ELEMENTS AND METHOD OF MAKING SAME, by Maxik, published on Sep. 22, 2005, describes using as a source of light generation, electronically activated light emitting elements, such as light emitting diodes, organic crystals and the like to provide one or more functions and are surface mounted on a flexible substrate that can bend and conform to a pre-established structure. In addition, standoffs of varying lengths are used to provide adjustable distances between the flexible substrate and the housing of the LED light bulb to provide adjustable light dispersion patterns. In this case, the circuit board is adapted to extend about and fit within the interior surface of a light bulb with the light emitting elements carried on the circuit board. A center post can be used to extend electrical conductors to the circuit board from the base and, if required, a power supply can also be carried in the post. A portion of the circuit board itself could also operate as the post.

None of these patents or published patent applications, individually or in any combination, teaches or suggests the features of the present invention.

Accordingly, it is a primary object of the invention to enhance the art of LED lamp retrofit kits.

Another object of the invention is to provide simplified retrofit LED fixture that allows installation in an existing downlight location.

A further object of the invention is a retrofit LED fixture that does not require modification to an existing downlight location.

A still further object of the present invention is a retrofit LED fixture that does not require tools for installation into an existing downlight location.

### SUMMARY OF THE INVENTION

The present invention is a retrofit downlight light module (DLM) comprising a light emitting diode (LED) having a housing with an LED downlighting module containing a lighting exit port and connected to a reflector and trim ring having an illumination outlet. In one embodiment, the DLM is inserted within an access hole after the existing fixture has been removed. A helical torsion spring twists on contact with the lower surface of the ceiling surrounding the hole perimeter, and subsequent to the coils of the spring passing the lower surface of the ceiling, the spring begins to apply a frictional force to the hole perimeter thereby retaining the DLM in the access hole without the need for tools.

### BRIEF DESCRIPTION OF THE DRAWINGS

A complete understanding of the present invention may be obtained by reference to the accompanying drawings, when considered in conjunction with the subsequent detailed description, in which:

FIG. 1 is a perspective view of a downlight LED retrofit module in accordance with the present invention;

FIG. 2 is an exploded perspective view of the downlight LED retrofit module of the invention;

FIG. 3 is an enlarged perspective view of the downlight LED retrofit retention spring; and

FIGS. 4 through 6 are perspective views of the installation sequence of the downlight LED retrofit module.

### DETAILED DESCRIPTION OF THE PREFERRED EMBODIMENT

The invention is a downlight LED retrofit module having a downlighting module (DLM), heat sink, DLM cooler, driver module, and a reflector. There are generally two parts to recessed lights: the trim and the housing. The trim is the visible portion of the light seen from the outside after installation, usually aesthetically pleasing to the eye. The insert is what is seen when looking up into the fixture, and also includes the thin lining around the edge of the light; the insert is part of the housing fixture that is installed inside the ceiling and contains the lamp holder.

The present invention permits the installation of the housing and trim in one step, without the use of any tools needed for other types of retrofit kit installations. This gives the installer the ability to install a retrofit kit, while not having to carry an assortment of tools, such as wrenches and saws.

The downlight LED retrofit module utilizes brackets, torsion springs, and threaded rods that are connected to the DLM in one embodiment. The downlight LED retrofit module uses the torsion springs to hold the fixture in place within the cut-out from whence the old lighting fixture was removed.

The downlight LED retrofit module of the present invention has a housing having an integrated trim ring as a part of the reflector. The combination of the integrated trim ring providing a hard stop on the outer exposed surface of the cut out and torsion spring engaging the inner edge of the same cut-out provides locating and retention capabilities for the installed downlight LED retrofit module.

Referring now to FIG. 1, there is shown a perspective view of the inventive downlight LED retrofit module 10. Reflector 11 is hollow and shaped to distribute light created by the downlight module assembly (DLM), shown generally at reference numeral 13. A retention bracket 15 encompasses several parts that are described in greater detail in FIG. 2, hereinbelow.

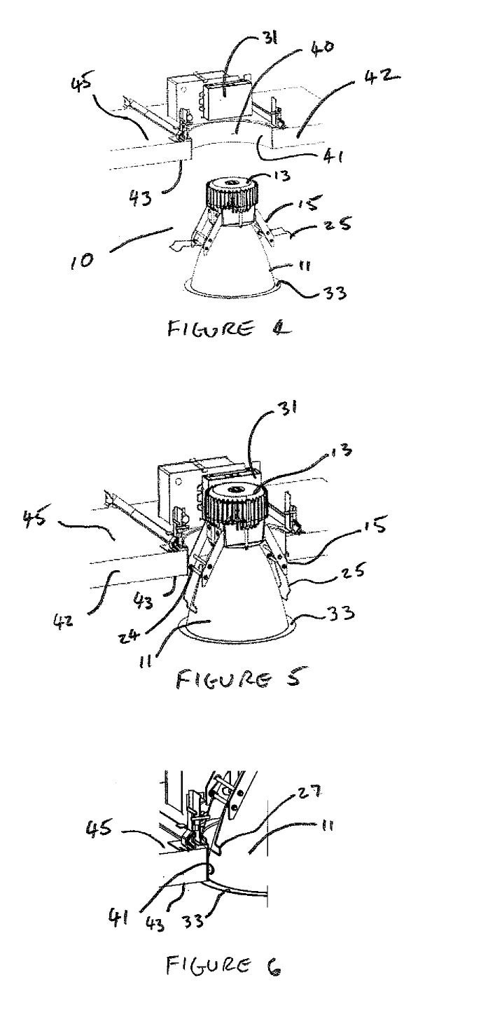

Referring now to FIG. 2, there is shown an exploded perspective view of downlight LED retrofit module 10. DLM 13 is made of an LED based downlight 16 and associated finned heat sink 17. Retention bracket 15 encompasses bracket 23 mechanically attached to connection point 16′ located on LED downlight 16 and threaded rod 21 and 21′ combining to retain spacers 22 and 22′ within bracket 23. A torsion spring 25 having retention arms 26 is positioned proximate spacers 22, 22′. In an alternate embodiment, retention arms 26 may be replaced with a different material, such as sheet metal or plastic, and a flat spring or traditional helical spring substituted for torsion spring 25. Retention bracket 15 may also provide enough elasticity to retain DLM 13 in place within access hole 40 (FIG. 4).

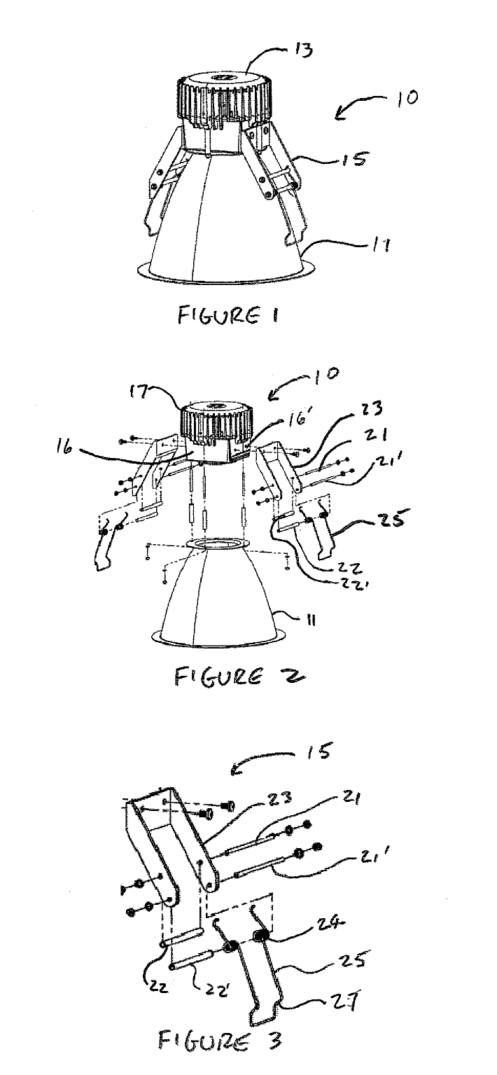

FIG. 3 is an enlarged view of retention bracket 15 that encompasses bracket 23, threaded rod 21 and 21′, spacers 22 and 22′, and torsion spring 25, having a capture point 27.

FIGS. 4 through 6 are perspective views of the installation sequence of a downlight LED retrofit module. FIG. 4 is a slightly elevated perspective view showing downlight LED retrofit module 10 in position below an access hole 40 in a ceiling 42. A driver module 31 is installed on upper surface 45 of ceiling 42 and ready to accept connections to downlight LED retrofit module 10. Torsion spring 25 is assembled with the spring retention arms 26 being tensed outwardly from reflector 11.

As downlight LED retrofit module 10 is lifted into access hole 40 (FIG. 5), retention arms 26 contact lower surface 43 of ceiling 42 and begin to rotate torsion springs 25 down due to movement restriction of spacers 22 and 22′ positioned on threaded rod 21 and 21′. Torsion springs 25 are compressed and store potential energy within their coils 24.

As downlight LED retrofit module 10 is fitted into access hole 40 (FIG. 6), coil 24 passes lower surface 43 of ceiling 42 and acts as a pivot point as retention arm 26 contacts inner surface 41 of ceiling access hole 40 and begins to drag along inner surface 41 of ceiling access hole 40 due to the stored energy within coils 24, creating an outward force. As the integrated trim ring 33 of reflector 11 seats on the lower surface 43 of ceiling 42, the compression of spring 25 is released through retention arms 26 against the inner wall 41 of access hole 40 that restricts the downward movement of retrofit module 10 due to gravity.

In an alternate embodiment, capture point 27 of retention arm 26 extends to upper surface 45 of ceiling 42, thereby retaining downlight LED retrofit module 10. The compression force of torsion spring 25 and the physical interference fit of capture point 27 breech inner surface 41 and rest on upper surface 45 of ceiling 42, providing a second means of retention.

It should be understood that downlight LED retrofit module 10 may be incorporated into other shapes. Moreover, integrated trim ring 33 and reflector 11 may take other forms and embodiments than those shown in the FIGURES. For example, squares, ovals, and rhombi are all considered within the scope of the present invention.

Since other modifications and changes varied to fit particular operating requirements and environments will be apparent to those skilled in the art, this invention is not considered limited to the example chosen for purposes of this disclosure, and covers all changes and modifications which does not constitute departures from the true spirit and scope of this invention.

Having thus described the invention, what is desired to be protected by Letters Patent is presented in the subsequently appended claims.

What is claimed is:

1. A method of retrofitting a light emitting diode (LED) downlight light module (DLM) comprising a housing and a lighting exit port connected thereto for emitting generated light, said DLM having a reflector and trim ring comprising an outlet connected thereto for dispensing illumination, the steps comprising:
a) positioning said DLM within an access hole having a predetermined perimeter;
b) compressing a retention device connected to said DLM;
c) releasing said retention device; and
d) restraining said DLM in said access hole.

2. The method of claim 1, wherein said compressing a retention device step (b) comprises insertion of said DLM into said access hole.

3. The method of claim 1, wherein said positioning of said DLM within said access hole step (a) further comprises using an installation location.

4. The method of claim 2, wherein said compressing a retention device step (b) further comprises contacting said retention device with said access hole perimeter.

5. The method of claim 4, wherein said compressing a retention device step (b) captures mechanical energy.

6. The method of claim 5, wherein said mechanical energy is partially released into said access hole perimeter.

7. The method of claim 6, wherein at least a portion of said mechanical energy is converted to friction energy within said access hole perimeter and applied thereto.

8. The method of claim 7, wherein said friction energy within said access hole perimeter retains said DLM in said access hole.

9. The method of claim 4, further comprising subjecting said retention device to a mechanical interference fit in said access hole.

10. In a light emitting diode (LED) retrofit downlight light module (DLM), the improvement comprising:
a) a reflector;
b) a trim ring;
c) means for locating said DLM within an access hole in a surface chosen from the group: planar and curved, said access hole having a predetermined perimeter;
d) a retention device on said DLM;
e) means operatively connected to said retention device for the releasing and the compression thereof; and
f) means for restraining said DLM in said access hole.

11. The DLM of claim 10, wherein said means for said compressing said retention device comprises means for inserting said DLM into said access hole.

12. The DLM of claim 11, wherein said means for compressing said retention device comprises physical contact of said retention device with said access hole perimeter.

13. The DLM of claim 12, wherein friction energy within said access hole perimeter is applied thereto.

14. The DLM of claim 13, wherein said friction energy within said access hole perimeter retains said DLM therein.

15. The DLM of claim 14, wherein said retention device creates a mechanical interference fit thereof in said access hole perimeter.
